(19) United States
(12) Patent Application Publication
(10) Pub. No.: US 2025/0279600 A1
(43) Pub. Date: Sep. 4, 2025

(54) CARD EDGE CONNECTOR MOUNTED ON A CIRCUIT BOARD

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: KUO-CHUN HSU, New Taipei (TW); XUN WU, Huaian (CN); ZHAO-XUAN CHEN, Huaian (CN)

(21) Appl. No.: 19/066,772

(22) Filed: Feb. 28, 2025

(30) Foreign Application Priority Data
Feb. 29, 2024 (CN) 202420389519.2

(51) Int. Cl. H01R 12/71; H01R 12/70; H01R 12/72; H01R 12/73; H01R 13/504; H01R 13/621; H01R 13/629

(52) U.S. Cl. CPC H01R 12/716; H01R 12/7047; H01R 12/721; H01R 12/735; H01R 13/504; H01R 13/6215; H01R 13/62938

(57) ABSTRACT

A card edge connector mounted on a circuit board includes an insulating housing having two side walls extending along a longitudinal direction, plural terminals retained in the insulating housing, at least one nut fixed in the insulating housing adjacent to the side walls, and a bolt matching the nut to bolt the card edge connector to the circuit board.

### BACKGROUND OF THE INVENTION

### Field of the Invention

The present invention relates to a card edge connector, and particularly to a card edge connector mounted on a circuit board.

### Description of Related Arts

China Patent No. 217444661 discloses a card edge connector for mounting on a circuit board and for mating with a mating member, including an insulating body, a plurality of terminals retained in the insulating housing, a locking member mounted to the insulating body, and a shell covering the insulating housing. The locking member is used to lock and release the mating member. When in use, the locking member may cause the card edge connector to shake inevitably.

Therefore, it is desired to provide a new card edge connector.

### SUMMARY OF THE INVENTION

An object of the present invention is to provide a card edge connector that is kept on the circuit board stably.

To achieve the above-mentioned object, a card edge connector mounted on a circuit board comprises an insulating housing extending along a longitudinal direction, a plurality of terminals retained in the insulating housing, at least one nut fixed in the insulating housing, and a bolt matching the nut to bolt the card edge connector to the circuit board.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of a card edge connector mounted on the circuit board of an embodiment of this present invention;

FIG. 2 is another perspective view of a part of the card edge connector mounted on the circuit board in FIG. 1;

FIG. 3 is an exploded perspective view of the card edge connector mounted on the circuit board in FIG. 1;

FIG. 4 is a further exploded perspective view of the card edge connector mounted on the circuit board in FIG. 3;

FIG. 5 is a cross-sectional view of the card edge connector mounted on the circuit board taken along line A-A in FIG. 1; and

FIG. 6 is another perspective view of a card edge connector in FIG. 1;

### DETAILED DESCRIPTION OF THE PREFERRED EMBODIMENT

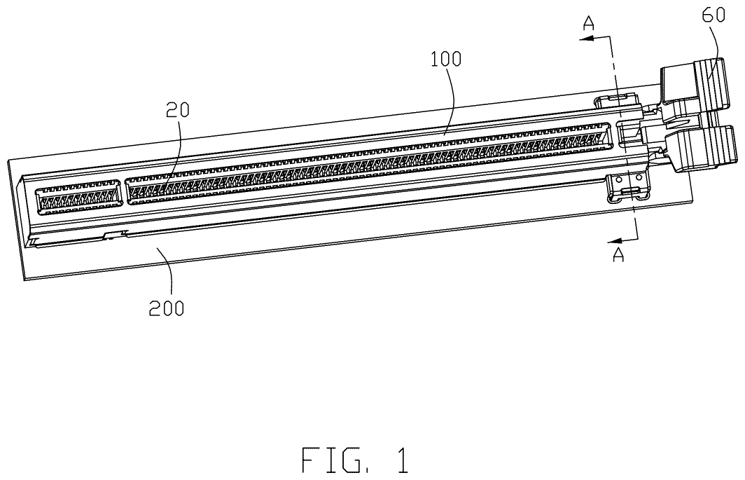

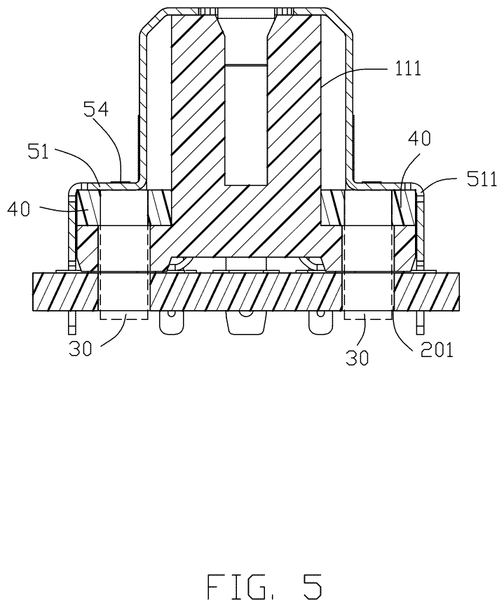

FIGS. 1-6 show a card edge connector 100 of a preferred embodiment of this present invention, the card edge connector is mounted on a circuit board 200 and secured on the circuit board 200 by at least one bolt 30 (as shown in FIG. 5). The card edge connector 100 includes an insulating housing 10 extending along a longitudinal direction, a plurality of terminals retained in the insulating housing 10 and nuts 40. The nuts 40 are fixed in the insulating housing 10 for bolts 30 to pass through, thereby bolting the card edge connector 100 on the circuit board 200.

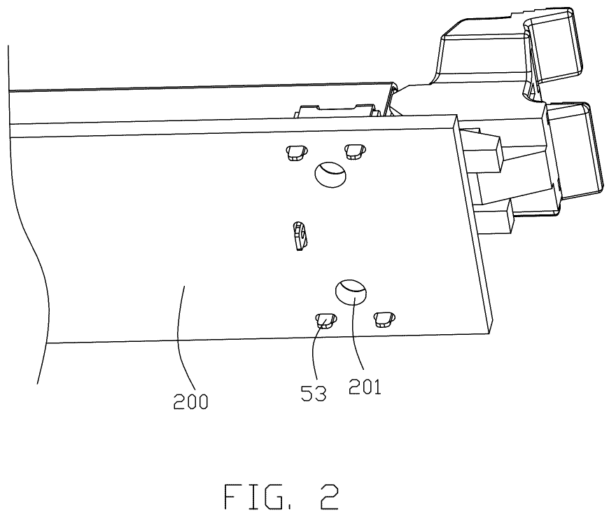

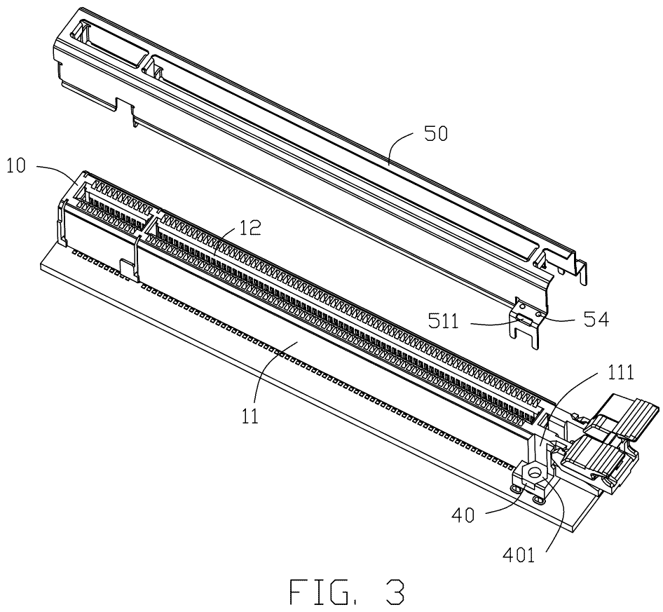

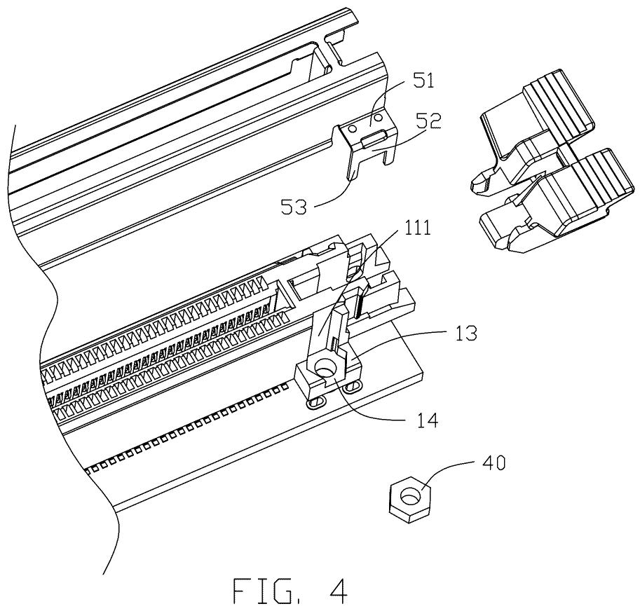

Referring to FIGS. 2-4, the bolts 30 pass through the circuit board 200 across through holes 201 defined on the circuit board and are screwed into the nuts 40. To be detailed, the bolts 30 pass through the circuit board 200 upwards from a lower face of the circuit boards and finally fixed to the nuts 40. Referring to FIGS. 3-4, the insulating housing 10 includes two side walls 11 and a card slot 12 opening upwardly between the two side walls 11. A couple of support portions 13 extends outside in a lateral direction perpendicular to the longitudinal direction from the side walls 11, the support portions are located at opposite longitudinal ends of the side walls 11. Each support portion 13 includes a notch 14 opening upwardly for receiving the nut 40 and a passageway 15 extending downwardly from the notch 14. The shape of the notch 14 is fit to the nut 40, so that the nut is un-rotated in the notch 14. The bolt 30 goes through the through hole 201 of the circuit board 200 and the passageway 15 of the support portion 13 until the bolt 30 is screwed into the nut 40. As a result, the insulating housing 10 is secured on the circuit board 200 stably.

Referred to FIGS. 4-5, the side wall 11 includes a sliding groove 111 recessed from an outer face thereof, opening upwardly and communicating downwardly with the notch 14. The notch 14 is of a hexagon with six sides. The shape of the sliding groove 111 matches a part shape of the notch 14 when viewed in an upper to lower direction, so that the nut 40 is installed into the notch 14 along the sliding groove 111downwards. The card edge connector 100 includes a metal shell 50 covering outside. The metal shell 50 includes a horizontal portion 51 attached to the top surface of each support portion 13 and a vertical portion 52vertically bending downward from the horizontal portion 51. The vertical portion 52 has a board pin 53 extending downwardly. Therefore, the horizontal portion 51 helps to secure the metal shell 50 on the insulating housing 10. What's more, the board pin 53 strengthens the stability of the insulating housing 10 and secures the insulating housing 10 on the circuit board 200. In addition, as shown in FIGS. 3-5, the notch 14 opens upwardly and the top surface 401 of the nut 40 is exposed to an exterior. The horizontal portion 51 covers the top surface of the nut 40. Therefore, the nut 40 is limited from moving upwards. The notch 14 opens outside laterally, the vertical portion covers one of the six sides to limit the nut in the lateral direction. The metal shell 50 covers the insulating body 10, and is welded with the top surfaces 401 of the nuts 40 by spot welding. Specifically, the horizontal portions 51 are spot welded to the top surfaces 401 of the nuts 40 and each forms a solder joint 54. In alternative embodiment, a laser welding is used to replace the spot welding. In addition, an opening 511 is arranged at the junction of the horizontal portion 51 and the vertical portion 52, and the opening 511 exposes the nut 40 and communicates with the exterior on the top surface of the nut 40. The horizontal portions 51 are welded with the top surfaces 401 of the nuts 40 and the board pins 53 further extend downwardly from the horizontal portions 51 so that the nuts 40 and the bolts 30 are fixed on the insulating body 10, and the whole card edge connector 100 is stabilized on the circuit board 200.

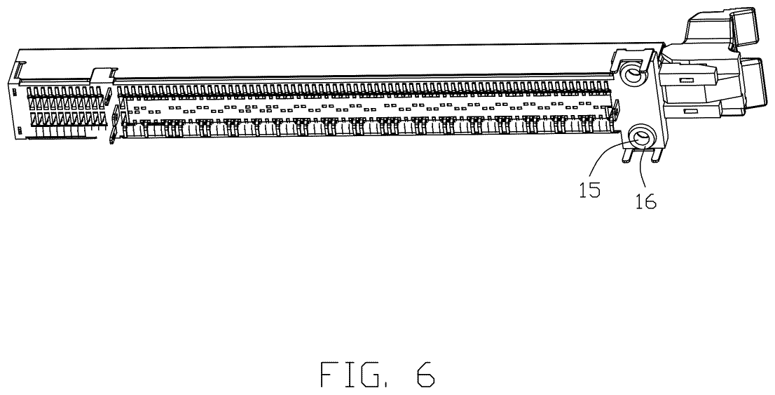

As shown in FIG. 4 and FIG. 6, one end of the insulating housing 10 is pivoted with a locking member 60, the support portion 13 is located adjacent to the locking member 60. The bottom surface of the supporting portion 13 has a raised portion 16 protruding towards the circuit board 200. The passageway 15 penetrates the raised portion 16 downwardly. The raised portion 16 contributes to support the insulating housing 10.

The above-mentioned embodiments are only preferred embodiments of the present invention, and should not limit the scope of the present invention, any simple equivalent changes and modifications made according to the claims of the present invention and the contents of the description should still belong to the present invention.

1. A card edge connector assembly comprising:
a circuit board having two holes;
two bolts;
a longitudinal insulating housing including two side walls extending along a longitudinal direction and two support portions at a first longitudinal end of the side walls, each of the support portions having a notch opening upwards and a passageway extending from the notch to a bottom of the support portion;
a plurality of terminals retained in the insulating housing; and
two nuts received in corresponding notches;
wherein the bolts extend from a bottom of the circuit board across corresponding holes and corresponding passageways and are retained with corresponding nuts to secure the insulating housing to the circuit board.

2. The card edge connector assembly as claimed in claim 1, wherein the side wall includes a sliding groove recessed from an outer face thereof, and the sliding groove opens upwardly and communicates downward with the notch, and the sliding groove and a part of the notch are aligned as viewed in an upper-to-lower direction.

3. The card edge connector assembly as claimed in claim 1, further comprising a locking member located at the first longitudinal end of the insulating housing.

4. The card edge connector assembly as claimed in claim 3, wherein a raised portion protrudes from the bottom of the support portion towards the circuit board.

5. The card edge connector assembly as claimed in claim 3, wherein the notch is of a hexagon shape, and the nut has a matched shape with the notch.

6. The card edge connector assembly as claimed in claim 3, further comprising a metal shell, wherein the metal shell comprises two opposite side plates attached the side walls, a horizontal portion bending from each of the side plate and a vertical portion bending from the horizontal portion, and a board pin extending from the vertical portion, the horizontal portion covers a top surface of the support portion, and the vertical portion covers a side face of the support portion.

7. The card edge connector assembly as claimed in claim 4, wherein the notches open upwards and outwards, the horizontal portion covers a top of the nut, and the vertical portion covers a side of the nut.

8. A card edge connector adapted for being mounted on a circuit board, comprising:
a longitudinal housing having a card slot extending along a longitudinal direction thereof;
a plurality of terminals retained in the insulating housing;
a locking member located on a first longitudinal end of the housing;
two nuts; and
two support portions integrally extending outwards in a lateral direction perpendicular to the longitudinal direction from opposite sides of the housing and located proximate to the locking member;
wherein each of the supporting portion has a notch and a passageway opening from the notch and running through the support portion, and the nuts are received in the notches respectively.

9. The card edge connector as claimed in claim 8, further comprising a metal shell surrounding the housing and covering the support portion, and wherein the nut is sandwiched between the support portion and the metal shell.

10. The card edge connector as claimed in claim 9, wherein the metal shell and the nut are spot-welded.

11. The card edge connector as claimed in claim 9, wherein the metal shell and the nut are secured by laser welding.

12. The card edge connector as claimed in claim 8, further comprising a metal shell, wherein the metal shell comprises two side plates attached to the housing in the longitudinal direction, a horizontal portion bending from each of the side plates, a vertical portion bending from the horizontal portion, and a board pin extending from the vertical portion, the horizontal portion covers a top surface of the support portion, and the vertical portion covers a side of the supporting portion.

13. The card edge connector as claimed in claim 12, wherein the notches open upwards and outwards, the horizontal portion covers a top of the nut, and the vertical portion covers a side of the nut.

14. A card edge connector adapted for being mounted on a circuit board, comprising:
an insulating housing extending along a longitudinal direction thereof;
a locking member pivotally connected to a first longitudinal end of the insulating housing in the longitudinal direction;
a plurality of terminals retained in the insulating housing;
a metal shell covering the insulating housing; and
two support portions extending from the insulating housing and located proximate to the locking member; wherein
the metal shell has two portions attached to top surfaces of the support portions and extending to the circuit board.

15. The card edge connector as claimed in claim 14, wherein a raised portion protrudes from each of the support portions towards the circuit board.

16. The card edge connector as claimed in claim 14, wherein the metal shell comprises two side plates attached to the housing in the longitudinal direction, a horizontal portion bending from each of the side plates, a vertical portion bending from the horizontal portion, and a board pin extending from the vertical portion, the horizontal portion covers a top surface of the support portion, and the vertical portion covers a side of the supporting portion.

17. The card edge connector as claimed in claim 16, wherein each of the supporting portions has a notch opening upwards for receiving a nut fixed to a bolt to secure the card edge connector to the circuit board.

18. The card edge connector as claimed in claim 17, wherein the notches open upwards and outwards, the horizontal portion covers a top of the nut, and the vertical portion covers a side of the nut.

19. The card edge connector as claimed in claim 18, wherein the horizontal portions are welded to the top surfaces of the nuts.

20. The card edge connector as claimed in claim 19, wherein an opening is arranged at the junction of the horizontal portion and the vertical portion, and the opening exposes the nut and communicates with exterior on the top surface of the nut.
